(19) United States
(12) Patent Application Publication
(10) Pub. No.: US 2022/0295602 A1
(43) Pub. Date: Sep. 15, 2022

(54) FLEXIBLE HEATING ELEMENT, FABRICATION METHOD THEREFOR, FLEXIBLE HEATING ASSEMBLY THEREOF, AND AEROSOL GENERATOR

(71) Applicant: SHENZHEN SMOORE TECHNOLOGY LIMITED, SHENZHEN (CN)

(72) Inventors: Hongming ZHOU, Shenzhen (CN); Zhenqian CHENG, Shenzhen (CN); Junjie XIAO, Shenzhen (CN)

(21) Appl. No.: 17/829,646

(22) Filed: Jun. 1, 2022

Related U.S. Application Data
(63) Continuation of application No. PCT/CN2020/120691, filed on Oct. 13, 2020.

(30) Foreign Application Priority Data
Dec. 20, 2019 (CN) 201911327773.X

(51) Int. Cl. H05B 3/36; H05B 3/12; A24F 40/46; A24F 40/70

(52) U.S. Cl. CPC H05B 3/36; H05B 3/12; A24F 40/46; A24F 40/70; H05B 2203/013; H05B 2203/017

(57) ABSTRACT

A flexible heating body includes: a sheet-shaped flexible base; at least one heating circuit disposed on the base; a conductive circuit disposed on the base and connected to both ends of the at least one heating circuit; and a flexible protective film covering the at least one heating circuit. In an embodiment, the at least one heating circuit, the conductive circuit, or the protective film are all formed by magnetron sputtering coating.

### CROSS-REFERENCE TO PRIOR APPLICATION

This application is a continuation of International Patent Application No. PCT/CN2020/120691, filed on Oct. 13, 2020, which claims priority to Chinese Patent Application No. CN 201911327773.X, filed on Dec. 20, 2019. The entire disclosure of both applications is hereby incorporated by reference herein.

### FIELD

The present invention relates to the field of vaporization, and more specifically, to a flexible heating body, a manufacturing method and a using method thereof, and an aerosol generator.

### BACKGROUND

As a new type of electronic cigarette, a heat not burn cigarette mainly heats tobacco by accurately controlling a temperature after a heating body is energized, and can quickly release tobacco extracts in the tobacco under a low temperature condition, so that a consumer can have a smoking experience similar to that of conventional tobacco-burning cigarettes but with less harmful components being released. Currently, different types of heating bodies are launched at home and abroad to heat an aerosol-generating substrate such as tobacco. The heating bodies are, for example, a sheet-shaped heating body, a rod-shaped heating body, and a tubular heating body.

A principle of heating tobacco by the sheet-shaped heating body and rod-shaped heating body is that a heating sheet is inserted into a middle part of the cigarette, and after being energized, a resistance material on a surface of the heating sheet radiates heat to heat the tobacco and conducts the heat in the tobacco. According to this heating manner, the tobacco can be only inhaled after being preheated for a period of time (usually 15 s to 20 s) to fully heat the tobacco. Due to a small heating area, the amount of vapor is small (compared with a real cigarette) after the tobacco is baked. In addition, because the tobacco closest to the heating sheet is over-baked after a plurality of times of inhaling, a burnt taste occurs in the later stage of inhaling, and the taste consistency is poor.

A principle of heating tobacco by the tubular heating body is that a cigarette is inserted into a tube, and a resistance material on a wall surface of the tube radiates heat after being energized to heat the tobacco in the tube and conducts the heat in the tobacco. Theoretically, according to this heating manner, a contact area between the tobacco and the heating body can be increased, and a preheating time of the tobacco is shortened, so that vapor can be generated quickly. However, due to a gap between an inner wall of the tube and the cigarette, the heat conduction is slow, resulting in a long preheating time and a small amount of vapor in the early stage of heating.

Therefore, a heating body is urgently required that can quickly and fully heat the aerosol-generating substrate and generate a large amount of vapor through baking.

### SUMMARY

In an embodiment, the present invention provides a flexible heating body, comprising: a sheet-shaped flexible base; at least one heating circuit disposed on the base; a conductive circuit disposed on the base and connected to both ends of the at least one heating circuit; and a flexible protective film covering the at least one heating circuit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a manufacturing flowchart of a heating element according to some embodiments of the present invention;

FIG. 2 is a schematic structural diagram of a heating circuit of a heating body according to some embodiments of the present invention; and

FIG. 3 is a schematic structural diagram of a conductive circuit of a heating body according to some embodiments of the present invention.

### DETAILED DESCRIPTION

In various embodiments, the present invention provides a flexible heating body, a manufacturing method and a using method thereof, and an aerosol generator for the foregoing defects in the related art.

In an embodiment, the present invention provides a flexible heating body, including a sheet-shaped flexible base, at least one heating circuit disposed on the base, a conductive circuit disposed on the base and connected to both ends of each heating circuit, or a flexible protective film covering the at least one heating circuit.

In some embodiments, the at least one heating circuit, the conductive circuit, or the protective film are all formed by magnetron sputtering coating.

In some embodiments, the base is made of at least one of aluminosilicate fiber paper, a PI film, or a casting ceramic piece.

In some embodiments, the protective film is made of at least one of a casting piece, a nitride ceramic material, or an oxide ceramic material, and a thermal expansion coefficient of the protective film matches a thermal expansion coefficient of the base.

In some embodiments, the protective film is prepared by at least one of a ZrO₂ composite film, an Al₂O₃ composite film, a SiO₂ composite film, or a Si₃N₄ composite film through direct current or radio frequency magnetron sputtering, and a thickness of the protective film is 100 nm to 1000 nm.

In some embodiments, a thickness of the heating circuit is 1 μm to 3.5 μm, and a thickness of the conductive circuit is 1 μm to 5 μm.

In some embodiments, the heating body further includes an electrode lead connected to the conductive circuit.

In some embodiments, the heating circuit includes a transition layer disposed on the base and a heating layer disposed on the transition layer.

In some embodiments, the transition layer is made of at least one of Cr, ZrNi, or TiN, or the heating layer is made of at least one of Pt, AgPd, AuPd, PtRu, PtRh, NiCr, or NiCrAlY.

In some embodiments, the conductive circuit includes a bottom layer disposed on the base, an intermediate buffer layer disposed on the bottom layer, and a conductive layer disposed on the intermediate buffer layer.

In some embodiments, the bottom layer is made of at least one of pure Ti or pure Ni, the intermediate buffer layer is made of at least one of pure Ti or pure Ni, and the conductive layer is made of at least one of Au, Ag, or Cu.

The present invention further provides a manufacturing method for a flexible heating body, including the following steps:

S1, providing a sheet-shaped flexible base, and putting the base into a coating machine cavity;

S2, performing magnetron sputtering on the base to form at least one heating circuit;

S3, performing magnetron sputtering on the base to form a conductive circuit; and

S4, performing magnetron sputtering on the at least one heating circuit to form a protective film.

In some embodiments, in step S1, after being wiped and cleaned with alcohol, the base is placed in a coating machine cavity, the coating machine cavity is vacuumized and preheated, and a surface of the base is ion-cleaned; and

in step S4, argon and oxygen in a ratio of 1:1 are introduced until a working air pressure in the cavity is 0.4 Pa, and a SiO₂ target power supply, a ZrO₂ target power supply, an Al₂O₃ target power supply, or a Si₃N₄ target power supply is turned on, and sputtering is performed at a power density of 2 W/cm² to 6 W/cm² and at a range from a room temperature to 500° C. to form the protective film with a thickness of 100 nm to 1000 nm.

In some embodiments, step S2 includes:

performing magnetron sputtering on the base to form a transition layer; and

performing magnetron sputtering on the transition layer to form a heating layer.

In some embodiments, in step S2, argon is introduced until a working air pressure in the cavity is 0.5 Pa, a Cr target power supply, a ZrNi target power supply, or a TiN target power supply is turned on, and a film is coated on the base for 5 minutes to 15 minutes at a power density of 6 W/cm² to 8 W/cm² and at a room temperature to form the transition layer with a thickness of 10 nm to 200 nm; and

the Cr target power supply, the ZrNi target power supply, or the TiN target power supply is turned off, a NiCr target power supply, a NiCrAlY target power supply, a Pt target power supply, an AgPd target power supply, an AuPd target power supply, a PtRu target power supply, or a PtRh target power supply is turned on, and a film is coated on the transition layer for 60 minutes to 120 minutes at a power density of 6 W/cm² to 8 W/cm² and at a room temperature to form the heating layer with a thickness of 1 μm to 2.5 μm.

In some embodiments, step S3 includes:

performing magnetron sputtering on the base to form a bottom layer;

performing magnetron sputtering on the bottom layer to form an intermediate buffer layer;

performing magnetron sputtering on the intermediate buffer layer to form a conductive layer; and

soldering an electrode lead on the conductive layer to form a conductive electrode.

In some embodiments, in step S2, argon is introduced until a working air pressure in the cavity is 0.5 Pa, a Titanium target power supply or a Nickel target power supply is turned on, and a film is coated on the base for 5 minutes to 10 minutes at a power density of 6 W/cm² to 8 W/cm² and at a room temperature to form the bottom layer;

the Titanium target power supply or the Nickel target power supply is turned off, then the Nickel target power supply or the Titanium target power supply is turned on, and a film is coated on the bottom layer for 10 minutes to 30 minutes at the power density of 6 W/cm² to 8 W/cm² and at a room temperature to form the intermediate buffer layer; and

then the Nickel target power supply or the Titanium target power supply is turned off, a silver target power supply, a copper target power supply, or a gold target power supply is turned on, and a film is coated on the intermediate buffer layer for 30 minutes to 120 minutes at a power density of 4 W/cm² to 8 W/cm² and at a room temperature to form the conductive layer.

The present invention further provides a flexible heating element. The heating element is in a shape of a spiral cylinder, and the heating element includes the heating body according to any one of the above and an aerosol-generating substrate coated on a surface of a side of the heating body on which the at least one heating circuit is disposed.

In some embodiments, the aerosol-generating substrate is an aerosol-generating substrate to which a viscous substance is added, and a thickness of the aerosol-generating substrate is 0.5 mm to 1 mm.

The present invention further provides an aerosol generator, including the heating body according to any one of the above.

### Beneficial Effects

Implementing the present invention at least has the following beneficial effects: when the flexible heating body is in use, an aerosol-generating substrate can be coated on a surface of the heating body, and then the heating body coated with the aerosol-generating substrate can be wound into a shape of a spiral cylinder to form a heating element. This structure can increase a direct contact area and a heating area between the heating body and the aerosol-generating substrate. The heating body can heat the aerosol-generating substrate in all directions, and the aerosol-generating substrate is heated faster and more uniformly, which reduces a preheating time, so that the heating body can reach an instant inhaling mode, which has advantages such as fast vapor generation and a large amount of vapor.

To provide a clearer understanding of the technical features, objectives, and effects of the present invention, specific implementations of the present invention are described with reference to the accompanying drawings.

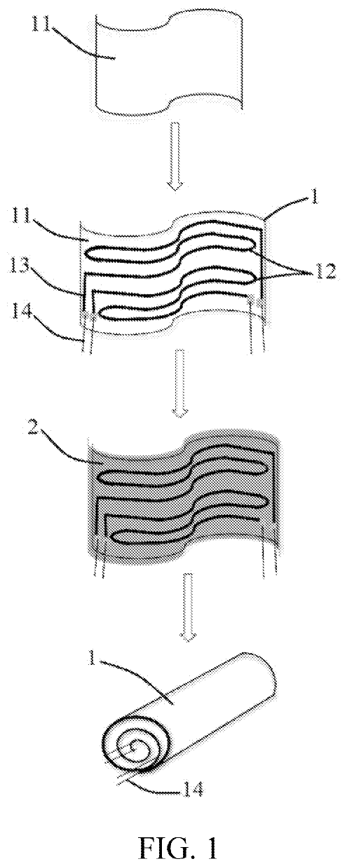

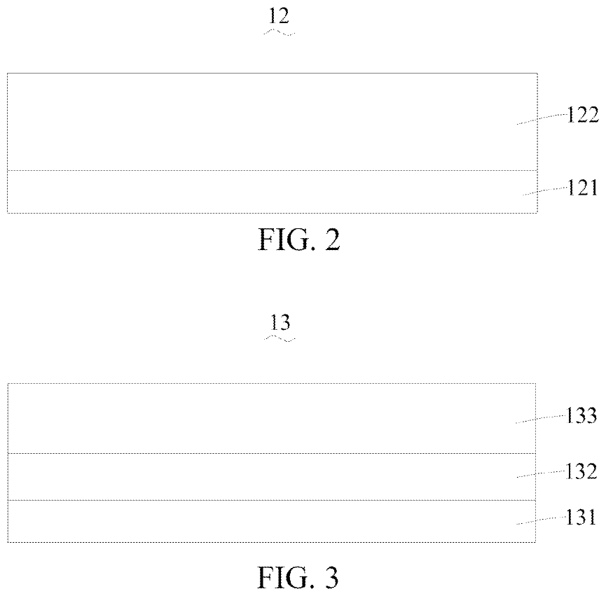

As shown in FIG. 1 to FIG. 3, the flexible heating element in some embodiments of the present invention includes a flexible heating body 1 and an aerosol-generating substrate 2 coated on a surface of a side of the heating body 1. The flexible heating body 1 includes a sheet-shaped flexible base 11, at least one heating circuit 12 disposed on the base 11, a conductive circuit 13 disposed on the base 11 and connected to both ends of each heating circuit 12, an electrode lead 14 connected to the conductive circuit 13, and a flexible protective film covering the at least one heating circuit 12.

When the flexible heating body 1 is in use, an aerosol-generating substrate 2 (for example, reconstituted tobacco added with a viscous substance) can be coated on the surface of the side of the heating body 1 on which the heating circuit 12 is disposed, and a thickness of the aerosol-generating substrate 2 may be 0.5 nm to 1 mm. Then the heating body 1 covered with the aerosol-generating substrate 2 is wound into a shape of a spiral cylinder to form a flexible heating element. This structure can increase a direct contact area and a heating area between the heating body 1 and the aerosol-generating substrate 2. The heating body 1 can heat the aerosol-generating substrate 2 in all directions, and the aerosol-generating substrate 2 is heated faster and more uniformly, which reduces a preheating time, so that the heating body 1 can reach an instant inhaling mode, which has advantages such as fast vapor generation and a large amount of vapor.

Two or more heating circuits 12 may be disposed on the base 11 of the heating body 1, and both ends of each heating circuit 12 are electrically connected to the electrode lead 14. The aerosol-generating substrate 2 can be heated by segments, so that the aerosol-generating substrate 2 can be heated sequentially by segments instead of being heated at one time, which improves the utilization of the aerosol-generating substrate and the inhaling convenience, and simultaneously can avoid a burnt smell produced by over-baking the baked aerosol-generating substrate, thereby improving the inhaling taste. Each heating circuit 12 can be distributed in an axial direction after winding (a width direction of the base 11 in this embodiment), or can be distributed in a circumferential direction after winding (a length direction of the base 11 in this embodiment), or can be distributed in the axial and circumferential directions after winding.

To ensure the uniformity of a temperature field in a heating region, the heating circuit 12 needs to be formed into a proper pattern, such as an S shape, a spiral shape, a wave shape, or the like. A pattern of the heating circuit 12 may be prepared by using a mask method or an ion etching method. The mask method is to form the pattern of the heating circuit 12 on the base 11 after sputtering the heating circuit 12 by masking a non-patterned position on the base 11. The ion etching method is to first plate the heating circuit 12 on a whole surface of the base 11, after photoresist is applied for exposure and curing, ion-etch the exposed photoresist and a region of the heating circuit 12, and then remove the unexposed photoresist to form a required pattern of the heating circuit 12. A pattern of the conductive circuit 13 may also be prepared by using the mask method or the ion etching method.

The heating circuit 12, the conductive circuit 13, and the protective film can be all formed by magnetron sputtering coating. A manner of magnetron sputtering can reduce the overall thickness of the heating body 1, and simultaneously can improve the resistance consistency of the pattern of the heating circuit 12 and reduce a fluctuation range of TCR, which is more conducive to precise temperature control of the heating field.

The base 11 can be a transparent or non-transparent flexible insulating sheet with high temperature resistance, corrosion resistance, and a stable material structure, and provide a carrier for the sputtered heating circuit 12 and the conductive circuit 13. In some embodiments, the base 11 may be made of at least one of a high temperature resistant flexible insulating polyimide film (namely, PI film), aluminosilicate fiber paper, or a flexible ceramic piece prepared by casting. The thickness of the base 11 may be 0.5 mm to 2 mm.

A function of the heating circuit 12 is to stably generate heat after being energized, and to heat an aerosol-generating substrate, which can usually be made of a metal material with high resistivity (that is, high resistance) and more generated heat. In some embodiments, the heating circuit 12 may be formed by sputtering metals such as Pt, AgPd, NiCr, and NiCrAlY, or alloy materials on the transition layer after direct current or radio frequency magnetron sputtering on is performed on the transition layer, and a thickness of the heating circuit 12 may be 1 μm to 3.5 μm.

In some embodiments, the heating circuit 12 includes a transition layer 121 disposed on the base 11 and a heating layer 122 disposed on the transition layer 121. The transition layer 121 mainly enhances a bonding force between the heating layer 122 and the base 11, increases the structural stability, prevents separation, and improves the bonding stability between a film and a base when the heating body generates heat circularly. The transition layer 121 may be made of an alloy that forms a stable chemical bond with both the base 11 and the heating layer 122, for example, the transition layer 121 may be made of at least one of Cr, ZrNi, or TiN. The heating layer 122 should be made of materials with high resistivity, more generated heat, stable material structure performance after high temperature heating, and good high temperature oxidation resistance and corrosion resistance, for example, precious metal materials such as Pt, or precious metal alloy materials such as AuPd, PtRu, PtRh, or AgPd, or high temperature resistant alloy materials such as NiCr and NiCrAlY.

One end of the conductive circuit 13 is connected to the heating circuit 12, and the other end is connected to the electrode lead 14 to be welded with the electrode lead 14 and supply power to the heating circuit 12. The conductive circuit 13 has low resistivity (that is, low resistance), and generates few heat. In some embodiments, the conductive circuit 13 may be formed by sputtering thin films such as an Ag thin film, an Au thin film, a Cu thin film after performing direct current or radio frequency sputtering pure Ti or Pure Ni, or plating the pure Ti and the pure Ni on the base. A thickness of the conductive circuit 13 may be equal to or slightly higher than the thickness of the heating circuit 12. In some embodiments, the thickness of the conductive circuit 13 may be 1 μm to 5 μm.

In some embodiments, the conductive circuit 13 may include a bottom layer 131 disposed on the base 11, an intermediate buffer layer 132 disposed on the bottom layer 131, and a conductive layer 133 disposed on the intermediate buffer layer 132. The bottom layer 131 and the intermediate buffer layer 132 may respectively be made of at least one of pure Ti or pure Ni. The bottom layer 131 and the intermediate buffer layer 132 are respectively formed by coating, which helps form a certain thickness, and can further increase the structural stability and prevent separation. The conductive layer 133 may be made of a metal material with good stability and conductivity, for example, the conductive layer 133 may be made of at least one of Au, Ag, Ni, or Cu. Generally, silver or copper may be used due to low costs.

A function of the protective film is to reduce the erosive effect of oxygen and impurities on the heating circuit 12, prevent the heating circuit 12 from reacting with the aerosol-generating substrate 2 during heating, and reduce an impact of the accumulation of soot on the inhaling taste. Part regions of the conductive circuit 13 and regions on the base 11 where the conductive circuit 13 and the heating circuit 12 are not disposed may also be covered with a protective film. Because the conductive circuit 13 needs to be welded with the electrode lead 14, a region where the conductive circuit 13 is welded with the electrode lead 14 is not covered by the protective film. In some embodiments, the protective film may be a ceramic material with good flexibility, a thermal expansion coefficient matching the base 11, good high temperature stability, easy to clean, and good corrosion resistance, for example, materials such as a casting piece and Si₃N₄, or oxide materials such as ZrO₂, Al₂O₃, and SiO₂. The protective film may be prepared by at least one of a ZrO₂ composite film, an Al₂O₃ composite film, a SiO₂ composite film, or a Si₃N₄ composite film through direct current or radio frequency magnetron sputtering, and a thickness of the protective film is 100 nm to 1000 nm.

The present invention further provides a manufacturing method for a flexible heating body, including the following steps:

S1. Processing before coating:

a sheet-shape flexible base 11 is provided, after the base 11 is wiped and cleaned with alcohol, the base 11 is placed in a coating machine cavity, the coating machine cavity is vacuumized and preheated, and a surface of the base 11 is ion-cleaned.

S2. Formation of the heating circuit 12:

Magnetron sputtering is performed on the base 11 to form the heating circuit 12.

Specifically, step S2 may include:

introducing argon until a working air pressure in the cavity is 0.5 Pa, turning on a Cr target power supply, and coating a film on the base 11 for 5 minutes to 15 minutes at a power density of 6 W/cm2 to 8 W/cm² and at a room temperature to form the transition layer 121 with a thickness of 10 nm to 200 nm; and

then turning off the Cr target power supply, turning on a NiCr target power supply, and coating a film on the transition layer 121 for 60 minutes to 120 minutes at a power density of 6 W/cm² to 8 W/cm² and at a room temperature to form the heating layer 122 with a thickness of 1 μm to 2.5 μm.

S3. Formation of the conductive circuit 13:

Magnetron sputtering is performed on the base 11 to form the conductive circuit 13.

Specifically, step S3 may include:

introducing argon until a working air pressure in the cavity is 0.5 Pa, turning on of a Titanium target power supply, and coating a film on the base 11 for 5 minutes to 10 minutes at a power density of 6 W/cm2 to 8 W/cm² and at a room temperature to form the bottom layer 131; turning off the Titanium target power supply;

then turning on the Titanium target power supply, and coating a film 131 on the bottom layer for 10 minutes to 30 minutes at the power density of 6 W/cm² to 8 W/cm² and at a room temperature to form the intermediate buffer layer 132; turning off the power supply of the Titanium target;

then turning on a silver target power supply, and coating a film on the intermediate buffer layer 132 for 30 minutes to 120 minutes at a power density of 4 W/cm² to 8 W/cm² and at a room temperature to form the conductive layer 133; and

soldering an electrode lead 14 on the conductive layer 133 to form a conductive electrode.

S4. Formation of the protective film:

Argon and oxygen in a ratio of 1:1 are introduced until a working air pressure in the cavity is 0.4 Pa, and sputtering is performed when a sputtering power density of a direct current SiO₂ target power supply is 2 W/cm² to 6 W/cm² and at a range from a room temperature to 500° C. to form the protective film with a thickness of 100 nm to 1000 nm.

The present invention further provides an aerosol generator, including a cavity for accommodating a heating element and a heating element disposed in the cavity, where the heating body 1 of the heating element, after being energized and heated up, bakes and heats the aerosol-generating substrate 2 for the user to inhale.

It can be understood that the foregoing technical features can be used in any combination without limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A flexible heating body, comprising:
a sheet-shaped flexible base;
at least one heating circuit disposed on the base;
a conductive circuit disposed on the base and connected to both ends of the at least one heating circuit; and
a flexible protective film covering the at least one heating circuit.

2. The heating body of claim 1, wherein the at least one heating circuit, the conductive circuit, or the protective film are all formed by magnetron sputtering coating.

3. The heating body of claim 1, wherein the base comprises at least one of aluminosilicate fiber paper, a PI film, or a casting ceramic piece.

4. The heating body of claim 1, wherein the protective film comprises at least one of a casting piece, a nitride ceramic material, or an oxide ceramic material, and
wherein a thermal expansion coefficient of the protective film matches a thermal expansion coefficient of the base.

5. The heating body of claim 1, wherein the protective film comprises at least one of a ZrO₂ composite film, an Al₂O₃ composite film, a SiO₂ composite film, or a Si₃N₄ composite film prepared through direct current or radio frequency magnetron sputtering, and
wherein a thickness of the protective film is 100 nm to 1000 nm.

6. The heating body of claim 1, wherein a thickness of the heating circuit is from 1 μm to 3.5 μm, and a thickness of the conductive circuit is from 1 μm to 5 μm.

7. The heating body of claim 1, further comprising:
an electrode lead connected to the conductive circuit.

8. The heating body of claim 1, wherein the heating circuit comprises a transition layer disposed on the base and a heating layer disposed on the transition layer.

9. The heating body of claim 8, wherein the transition layer comprises at least one of Cr, ZrNi, or TiN, and
wherein the heating layer comprises at least one of Pt, AgPd, AuPd, PtRu, PtRh, NiCr, or NiCrAlY.

10. The heating body of claim 1, wherein the conductive circuit comprises a bottom layer disposed on the base, an intermediate buffer layer disposed on the bottom layer, and a conductive layer disposed on the intermediate buffer layer.

11. The heating body of claim 10, wherein the bottom layer comprises at least one of pure Ti or pure Ni,
wherein the intermediate buffer layer comprises at least one of pure Ti or pure Ni, and
wherein the conductive layer comprises at least one of Au, Ag, or Cu.

12. A manufacturing method for a flexible heating body, comprising:
S1: providing a sheet-shaped flexible base, and putting the base into a coating machine cavity;
S2: performing magnetron sputtering on the base to form at least one heating circuit;
S3: performing magnetron sputtering on the base to form a conductive circuit; and
S4: performing magnetron sputtering on the at least one heating circuit to form a protective film.

13. The manufacturing method of claim 12, wherein in S 1, after being wiped and cleaned with alcohol, the base is placed in a coating machine cavity, the coating machine cavity is vacuumized and preheated, and a surface of the base is ion-cleaned; and
in S4, argon and oxygen in a ratio of 1:1 are introduced until a working air pressure in the cavity is 0.4 Pa; a SiO₂ target power supply, a ZrO₂ target power supply, an Al₂O₃ target power supply, or a Si₃N₄ target power supply is turned on; and sputtering is performed at a power density of from 2 W/cm² to 6 W/cm² and at a range from a room temperature to 500° C. to form the protective film with a thickness of from 100 nm to 1000 nm.

14. The manufacturing method of claim 12, wherein S2 comprises:
performing magnetron sputtering on the base to form a transition layer; and
performing magnetron sputtering on the transition layer to form a heating layer.

15. The manufacturing method of claim 14, wherein in S2, argon is introduced until a working air pressure in the cavity is 0.5 Pa; a Cr target power supply, a ZrNi target power supply, or a TiN target power supply is turned on; and a film is coated on the base for 5 minutes to 15 minutes at a power density of from 6 W/cm² to 8 W/cm² and at a room temperature to form the transition layer with a thickness of from 10 nm to 200 nm; and
wherein the Cr target power supply, the ZrNi target power supply, or the TiN target power supply is turned off; a NiCr target power supply, a NiCrAlY target power supply, a Pt target power supply, an AgPd target power supply, an AuPd target power supply, a PtRu target power supply, or a PtRh target power supply is turned on; and a film is coated on the transition layer for 60 minutes to 120 minutes at a power density of from 6 W/cm² to 8 W/cm² and at a room temperature to form the heating layer with a thickness of from 1 μm to 2.5 μm.

16. The manufacturing method of claim 12, wherein S3 comprises:
performing magnetron sputtering on the base to form a bottom layer;
performing magnetron sputtering on the bottom layer to form an intermediate buffer layer;
performing magnetron sputtering on the intermediate buffer layer to form a conductive layer; and
soldering an electrode lead on the conductive layer to form a conductive electrode.

17. The manufacturing method of claim 16, wherein in S2, argon is introduced until a working air pressure in the cavity is 0.5 Pa; a Titanium target or a Nickel target power supply is turned on; and a film is coated on the base for 5 minutes to 10 minutes at a power density of 6 W/cm² to 8 W/cm² and at a room temperature to form the bottom layer,
wherein the Titanium target power supply or the Nickel target power supply is turned off, then the Nickel target power supply or the Titanium target power supply is turned on, and a film is coated on the bottom layer for 10 minutes to 30 minutes at the power density of from 6 W/cm² to 8 W/cm² and at the room temperature to form the intermediate buffer layer, and
wherein then the Nickel target power supply or the Titanium target power supply is turned off; a silver target power supply, a copper target power supply, or a gold target power supply is turned on; and a film is coated on the intermediate buffer layer for 30 minutes to 120 minutes at a power density of from 4 W/cm² to 8 W/cm² at a room temperature to form the conductive layer.

18. A flexible heating element, comprising:
the heating body of claim 1; and
an aerosol-generating substrate coated on a surface of a side of the heating body on which the at least one heating circuit is disposed,
wherein the heating element is in a shape of a spiral cylinder.

19. The heating element of claim 18, wherein the aerosol-generating substrate comprises an aerosol-generating substrate to which a viscous substance is added, and
wherein a thickness of the aerosol-generating substrate is 0.5 mm to 1 mm.

20. An aerosol generator, comprising:
the heating body of claim 1.
